(19) United States
(12) Patent Application Publication
(10) Pub. No.: US 2009/0063985 A1
(43) Pub. Date: Mar. 5, 2009

(54) SYSTEM AND METHOD FOR CREATING AND MANAGING LABEL CONTENT

(75) Inventor: Chin Lin, LaGrange, KY (US)

Correspondence Address: STITES & HARBISON, PLLC, 400 W MARKET ST, SUITE 1800, LOUISVILLE, KY, 40202-3352, US

(73) Assignee: FETTER PRINTING COMPANY, Louisville, KY (US)

(21) Appl. No.: 12/200,185

(22) Filed: Aug. 28, 2008

Related U.S. Application Data
(60) Provisional application No. 60/968,451, filed on Aug. 28, 2007.

(51) Int. Cl. G06F 17/30; G06F 3/048; G06Q 10/00

(52) U.S. Cl. 715/733; 707/104.1; 705/10; 707/E17.009

(57) ABSTRACT

A system and method for creating and managing content for a plurality of labels, includes a database containing images of the labels and a server accessible to a plurality of customers over a network. A traffic manager module provides a user interface to a customer for review and approval of the labels following changes of the labels. An asset manager module provides a user interface for accessing the images and a current inventory status of each of the plurality of labels. The database further includes a plurality of label fields having a family level, a product level and a SKU level of data that have hierarchical relationships such that plurality of label fields use the family level of data unless exception data is present at the product or SKU levels of data. A content manager module allows simple family level and product level changes to the label content.

### BACKGROUND OF THE INVENTION

1. Field of the Invention

The present invention relates to creating and managing content for printed labels.

2. Background Art

The creating, editing and updating of labels, such as labels used with paint products, has always been very difficult. In an industry such as the paint industry, a single label update may affect tens, hundred or even thousands of labels for individual products (referred to as “stock keeping units” or “SKUs”). Prioritization and tracking of label jobs is difficult due to the large volume of individual labels that must be processed and coordinated for the editing and review process. Additionally, there are a large number of persons involved in the process, including the customer and the customer's third-party creative agencies, and various customer service, typesetters, production and others associated with the label printer/producer. It takes a coordinated effort by all of the persons involved to ensure that each label is edited, reviewed, and approved.

The transfer of information in this process is typically accomplished by e-mail. However, e-mail is not a desired method for the transfer of information regarding labels because, as graphics files grow in size, they tend to overwhelm the performance capabilities and capacity of many e-mail systems. An alternate method of file transfer is using file transfer protocol (FTP), but FTP does not provide notification when files have been transferred.

Thus, a better collaborative environment for updating labels is needed.

Further, following the collaboration process for updating labels, there is a need for managing such updated labels for future use and updating. Sometime, electronic format label files are kept in a shared hard-disk drive that gives rise to issues with keeping track of the electronic format label files.

In addition to managing the updated labels for future use, a record of the steps taken during the collaborative process would also be beneficial for tracking the history of individual labels.

Further still, when updating labels it is desired to know how many labels that have already been printed are in inventory, thereby potentially making those existing labels obsolete. Knowledge of existing labels in inventory is useful in managing updates to labels.

Even further still, with an improved collaborative environment in place and with an improved system and method for managing updated labels, it is desired to improve the current system of updating individual labels, one-at-a-time. For instance, in the paint industry, labels are created using graphics design software, which is used to modify one label at a time. Thus, making a common change across a product line, or a family of products results in editing a very large number of individual labels. When editing such large numbers of labels, aside from being time consuming, inconsistencies may be introduced in the changes, or other errors may be introduced in the editing process. Traditionally, making changes to labels for product lines or families of products has been handled with “brute force” labor and making the changes one-label-at-a-time. Thus, an improved way of making common changes to labels for a product line or family of products is needed.

### BRIEF SUMMARY OF THE INVENTION

The present invention meets these needs and others by providing a system and method for creating and managing label content.

According to one aspect of the invention, a system for creating and managing content for a plurality of labels, includes a database and a server in communication with the database and accessible to a plurality of customers over a network. The database contains images of each of the plurality of labels. The server includes: a traffic manager module for providing a user interface to a customer for customer review and approval of at least one of the plurality of labels following a change of the at least one of the plurality of labels; and an asset manager module for obtaining inventory information indicating a current inventory status of each of the plurality of labels, and for providing a user interface to the customer for accessing the images and the inventory status of each of the plurality of labels over the network.

In one implementation of the system each label has a plurality of label fields and belongs to of one of a plurality of product lines that each comprise a plurality of different labels for different stock keeping units (SKUs). The database further has a product level of data and a SKU level of data for the plurality of label fields. The product level of data and the SKU level of data have a hierarchical relationship such that plurality of label fields use the product level of data unless exception data is present at the SKU level of data. In this implementation, the system further includes a content manager module for providing a user interface for editing the product level of data and the SKU level of data for the plurality of label fields, and for generating an image of any label affected by the editing. The database may further have a family level of data having a hierarchical relationship with the product level of data and the SKU level of data. In this case, the plurality of label fields use the family level of data unless exception data is present at one of the product level of data and the SKU level of data.

In another implementation, the system includes a management module for providing a user interface for assigning user rights to the system, and for defining jobs within the system.

In yet another implementation, the database further contains a plurality of electronic media files, and the system further includes an element library module for providing a user interface to the customer for managing the electronic media files over the network.

According to another aspect of the invention, an exemplary method for creating and managing a plurality of labels, includes the steps of: in response to receiving a request from a customer to change a label, changing the label as requested; uploading a low resolution image of the label to the database for customer review over a network; in response to receiving an approval signal from the customer over the network, the approval signal indicating approval of the label, generating a high resolution image of the label; storing the high resolution image of the label to the database for access by the customer over the network; obtaining inventory information indicating a current inventory status of the label; and storing the inventory information to the database for access by the customer over the network.

In one implementation, the method further includes sending a notification to the customer that the low resolution image is ready for review following uploading the low resolution image of the label to the database. The method may further include receiving an annotated image with additional changes from the customer following the customer review, making the additional changes, uploading a new image of the label to the data base for further customer review over the network, and sending a notification to the customer that the new image is ready for review.

In another implementation, the customer review is conducted by a plurality of customer reviewers. Each of the plurality of customer reviewers reviews the low resolution image of the label over the network.

In yet another implementation, the method further includes storing a history of all actions taken with respect to the label in the database for access by the customer over the network.

In an even further implementation, the label contains text data, and the method further includes storing a copy of the text data to the database for searching by the customer over the network.

According to yet another aspect of the invention, an exemplary method for creating and managing content for a plurality of labels using “content management” includes the following steps: in response to receiving a request from a customer to create a plurality of labels that belong to one of a plurality of product lines that each comprise a plurality of different labels for different stock keeping units (SKUs), creating design templates for the labels, the design templates having a plurality of label fields for different parts of the labels; creating in a database a product level of data and a SKU level of data for the plurality of label fields, the product level of data and the SKU level of data having a hierarchical relationship such that plurality of label fields use the product level of data unless exception data is present at the SKU level of data; generating images of the new labels from the design templates and data from the database; and storing the images of the labels for customer review and approval over a network. The method may further includes the steps of: in response to a request to change the labels of a product line, changing the product level of data; generating a new image of each label of the product line; and storing the new image of each label of the product line for customer review and approval over a network.

In one implementation, the plurality of product lines belong to a family of products. The method then further includes creating in the database a family level of data having a hierarchical relationship with the product level of data and the SKU level of data such that the plurality of label fields use the family level of data unless exception data is present at one of the product level of data and the SKU level of data. Still further, the method may include: in response to a request to change the labels of the family of products, changing the family level of data; generating a new image of each label of the family of products; and storing the new image of each label of the family of products for customer review and approval over a network.

Other features and advantages of the invention will be set forth in, or apparent from, the detailed description of exemplary embodiments of the invention found below.

### BRIEF DESCRIPTION OF THE SEVERAL VIEWS OF THE DRAWINGS

These and other features, aspects, and advantages of the present invention will become better understood with regard to the following description, appended claims, and accompanying drawings where:

FIG. 1 is a block diagram of an exemplary system for creating and managing content for a plurality of labels according to the invention;

FIG. 2 is a functional block diagram providing an overview of the functions performed by software modules of a server of the system of FIG. 1;

FIG. 3 and FIG. 4 are flow diagrams showing a flow through a content management process using the system of FIG. 1;

FIG. 5 is a screen shot of an exemplary user interface screen for a content manager module of the system of FIG. 1;

FIG. 6 is a diagram of a structure of a portion of an exemplary database of the system of FIG. 1;

FIG. 7 is a diagram of a label template showing a plurality of label fields;

FIG. 8 is a flow diagram showing a flow through a traffic management process using the system of FIG. 1;

FIG. 9 is a screen shot of an exemplary user interface screen for a traffic manager module of the system of FIG. 1;

FIG. 10 is a screen shot of an exemplary user interface screen for an asset manager module of the system of FIG. 1; and

FIG. 11 is a screen shot of an exemplary user interface screen for an element library module of the system of FIG. 1.

### DETAILED DESCRIPTION OF EXEMPLARY EMBODIMENTS OF THE INVENTION

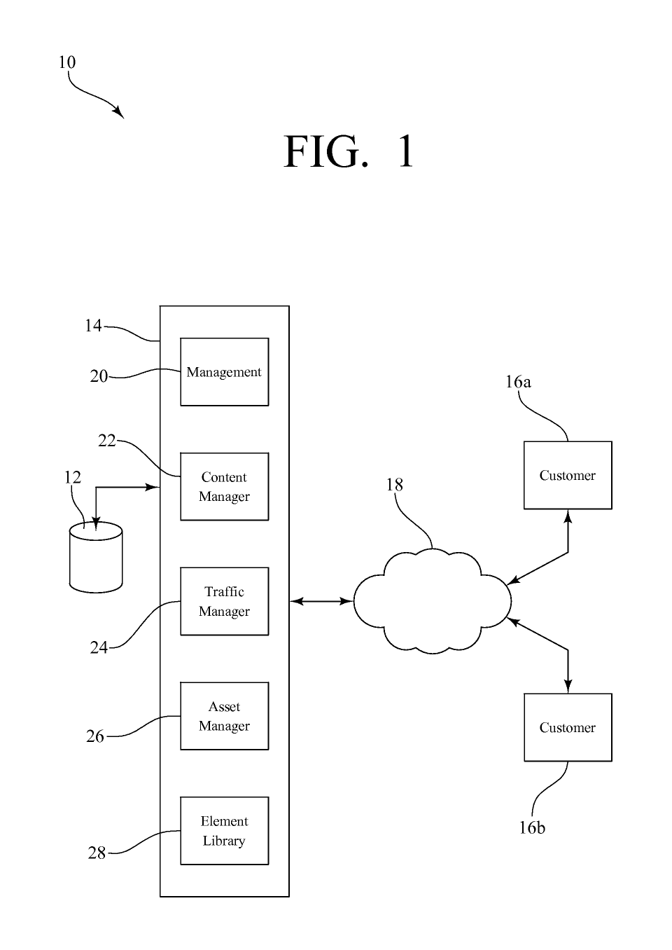

FIG. 1 is a block diagram of an exemplary system 10 for creating and managing content for a plurality of labels, including a database 12 and a server 14 accessible to a plurality of customers 16a, 16b over a network 18. The server 14 includes a management module 20, a content manager module 22, a traffic manager module 24, an asset manager module 26 and an element library module 28. Each of these components and their interactions will be described in more detail below.

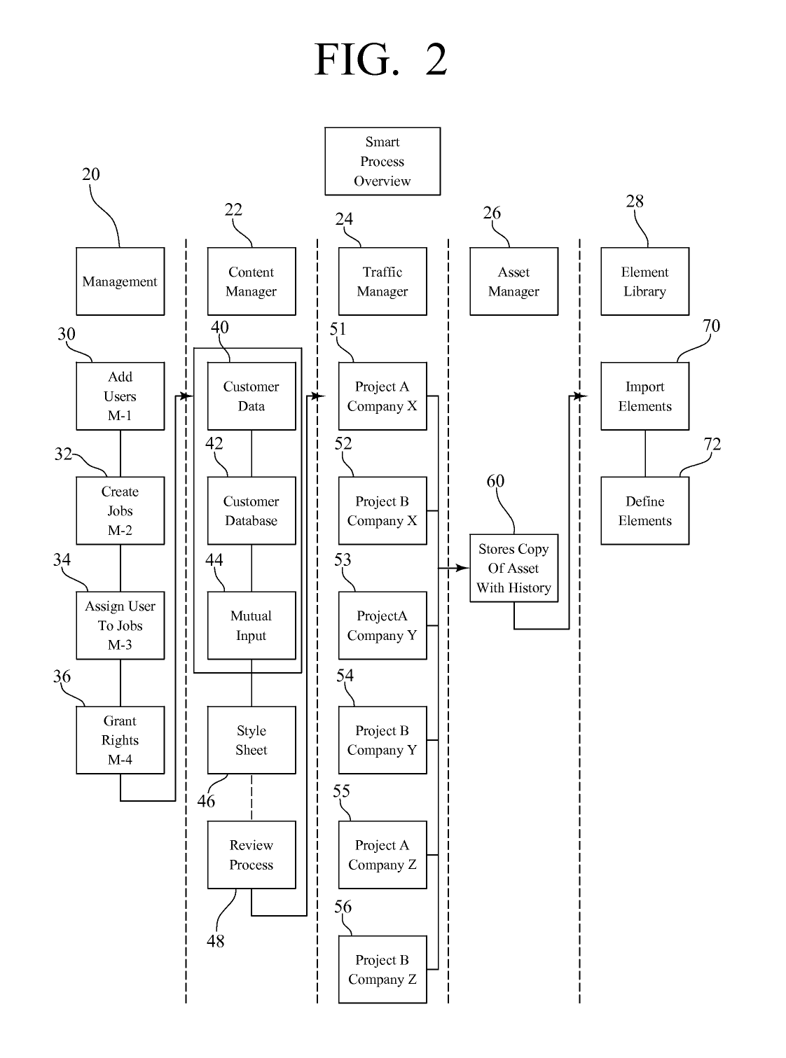

FIG. 2 provides an overview of the functions performed by the software modules of the server 14. Each of the software modules provides a user interface to the functionalities which are described below.

The management module 20 provides basic management functionality, including adding users 30, creating jobs 32, assigning users to jobs 34 and granting access rights to customers 16a, 16b and other users of the system 10. Jobs are initiated by customers 16a, 16b that wish to change a label or create new labels. A single job can group together a number of labels. To prevent confusion, users of the system 10 will see only controls for functions and modules of the server 14 to which they have access.

The content manager module 22 takes advantage of the hierarchical nature of many labels, such as paint can labels, to allow changes to be made at a family level or at a product level, as well as at the individual label level (the “SKU level”). For example, a change to a product warning that needs to appear on every label in a family can be made with one change that would update every label in the family. However, the labels must first be created using the content manager module 22, which entails receiving customer data 40, receiving information from a customer database 42, or manual data input 44. An example of customer data 40 is promotional wording. An example of information from a customer database 42 are scientific information regarding the chemical composition of a product. An example of manual input 44 is a translation that has been sent out to be translated into a foreign language, that could need to be cut-and-pasted or keyed in by hand. Also required is a style sheet 46 which contains the physical layout of each label, including label fields, text size information, and other layout information. After the labels are created using the content manager module 22, the labels are ready for a review process 48 to obtain approval before the labels are ready for production.

Under the traffic manager module 24 are multiple concurrent jobs 51, 52, 53, 54, 55, 56 that are undergoing the approval process simultaneously.

Once a label is approved, the asset manager module 26 stores a copy of the label (i.e. asset) together with historical data documenting the creation and approval process.

Lastly, the element library module 28 is a stand-alone module that controls art elements. Its functions include importing elements 70 and defining elements 72.

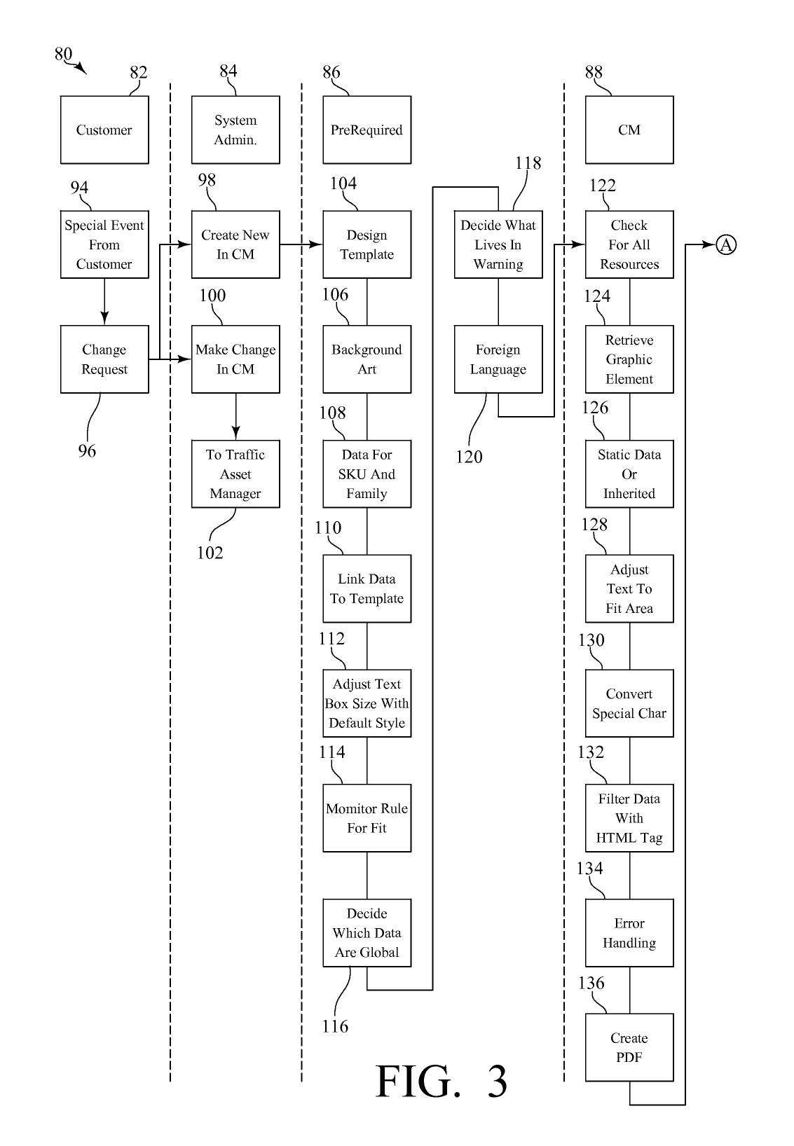

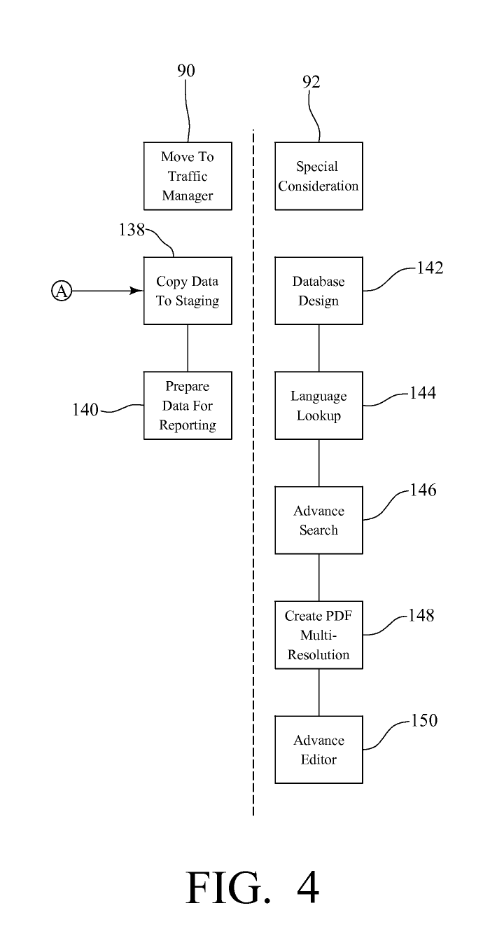

Turning now to FIG. 3 and FIG. 4, the flow through the content management process 80 is shown with respect to customer actions 82, system administrator actions 84, prerequisite actions 86, content management system actions 88, movement to traffic manager actions 90, and special considerations 92.

With respect to the customer actions 82, an event 94 occurs that initiates the creation of new labels or changes to existing labels. For instance, the customer could introduce a new product, or changes in the law may mandate changes to warnings on the labels, or the customer might just want to refresh the look and feel of the label. As a result of the event 94, the customer contacts the system administrator with a change request 96.

Then, depending on whether a prior version of the label has already been created using the content management process 80, the system administrator will either initiate creation of a new label 98 or just make the change to the previous version of the label 100. In the event of making the change to the previous version of the label 100, the next step 102 is proceeding into the traffic manager module 24 and the asset manager module 26 of the system 10 (FIG. 1), which will be discussed in more detail below. In the event that the system administrator initiates creation of a new label 98, the content management process 80 proceeds to the prerequisite actions 86.

With respect to the prerequisite actions 86, one action is creating a design template 104, which is usually created using graphics design software. The design template 104 is converted to become the style sheet 46 (FIG. 2). Another action is obtaining background art 106 for the label. Still further, data for the SKU and family 108 must be obtained, whether keyed in or from a customer database. Another action is linking the data to the template 110. Yet other actions are adjusting the text box size with default style 112 and monitoring rule for fit 114, to verify that the text fits in the text box provided using the default style (font and text size). Additional actions include deciding which data are global 116 and deciding which data are warnings 118. Lastly, an action is determining if there are foreign languages 120 that need to be translated.

The content management system actions 88 include: 122 checking for resources to make sure that a template and data exist; 124 retrieving graphic elements; 126 determining from database fields whether data is static or inherited; 128 adjusting text to fit area, based on the rules by reducing the text size by one percent increments until the text fits or a minimum size is reached; 130 converting data representing special characters to the actual special characters; 132 filtering data with HTML tags to convert the data to have the characteristics indicated by the HTML tags; 134 error handling, wherein the system detects errors and generates a report; and 136 creating an image (e.g. a “PDF format image”) of the label and moving the process to the traffic manager module 24.

The movement to traffic manager actions 90 include: 138 copying the image and related data to a staging area, so that the data can be “frozen” during the approval process; and 140 preparing historical action data for reporting.

The special considerations 92 for the content management process 80 include: 142 database design, for hierarchical flow; 144 language lookup, for translation between languages; 146 advance search, saving text appearing on the label as metadata to allow searching on the text; 148 create images with multiple resolutions, with lower resolution images being used for the approval process and higher resolution images being used for production of the label; and 150 advance editor, to allow text formatting using icon buttons rather than requiring knowledge of HTML tags.

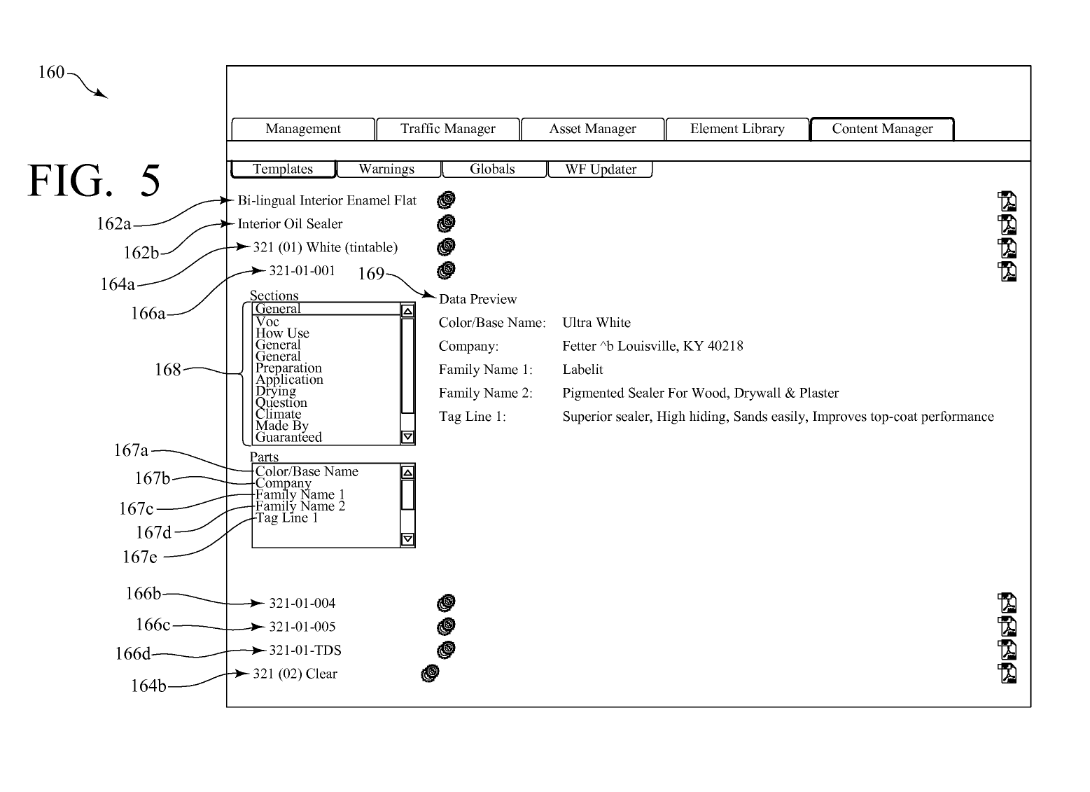

FIG. 5 is a screen shot of an exemplary user interface screen 160 for the content manager module 22, illustrating family level data 162a, 162b, product level data 164a, 164b, and SKU level data 166a, 166b, 166c, 166d formatted to be expandable headings revealing or hiding data at a lower level by clicking on the expandable headings. Also shown are label fields 167a-167e which are grouped into logical label field sections 168 and are accessed by selecting the appropriate label field section from the menu-like list of label field sections 168. Data for the label fields 167a-167e is displayed in a data preview portion 169 of the user interface screen 160.

The family level data 162 represent families of labels, for example, for a “Bi-lingual Interior Enamel Flat” 162a and an “Interior Oil Sealer” 162b paint product. Within the “Interior Oil Sealer” family, there are product lines represented by product level data 164 for a “White (tintable)” product 164a and a “Clear” product 164b. Within the “White (tintable)” product 164b, the actual labels are represented by SKU level data 166 representing different size cans (e.g. 1 gallon, 1 quart or 1 pint) 166a, 166b, 166c and a Technical Data Sheet (TDS) 166d.

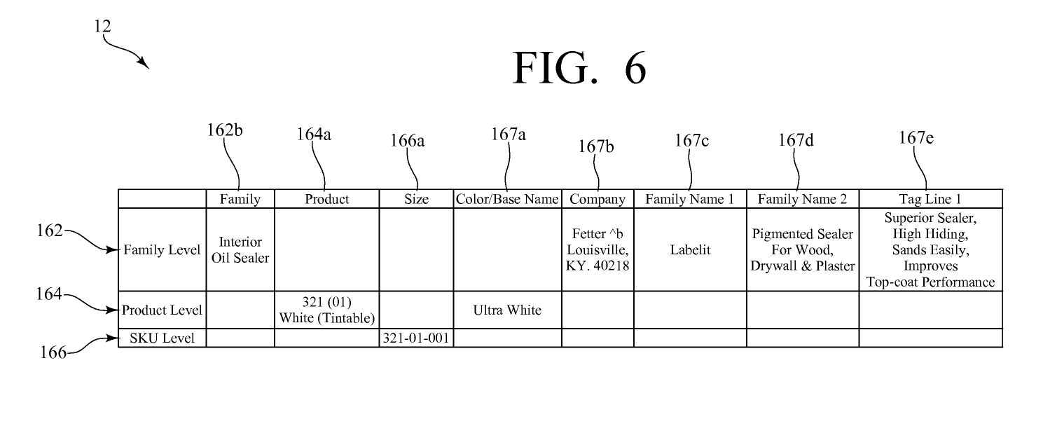

FIG. 6 shows a representative structure for a portion of the database 12 where the database 12 includes the family level of data 162, the product level of data 164 and the SKU level of data 166 for the label fields 167a-167e. The family level of data 162, the product level of data 164 and the SKU level of data 166 have a hierarchical relationship such that plurality of label fields use the family level of data unless exception data is present at one of the product level of data and the SKU level of data. Likewise, if there is product level data, that data is used unless there is exception data present at the SKU level of data. Thus, in the example shown, the “family” data 162b, the “company” data 167b, the “family name 1” data 167c, the “family name 2” data 167d, and the “tag line 1” data 167e are all at the family level of data 162. The “product” data 164a and the “color/base name” data 167a are at the product level of data 164. The “SKU” data 166a is at the SKU level of data 166.

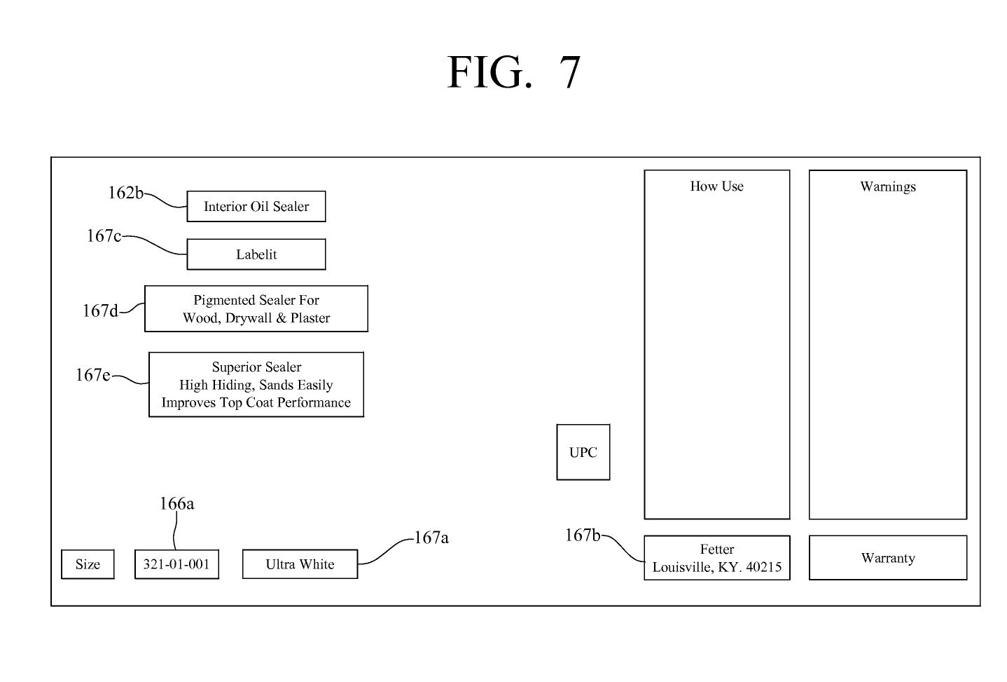

FIG. 7 shows a representative label template with the label fields 167a-167e populated with data from the database 12. The “family” data 162b and the “SKU” data 166a is also used in fields on the representative label template. Data from the family level of data 162, such as family names, company names and tag lines, is “inherited” by the appropriate label fields 162b, 167b-167e. Data that is an exception to the family level of data 162 at the product level of data 164, such as product identifiers and names, is “inherited” by other label fields 164a, 167a. Data that is an exception to both the family level of data 162 and the product level of data 164, such as UPC codes and product size information, is used in the remaining label fields 166a.

Advantageously, using the content manager module 22, data for the family level 162 and the product level 164 can be updated with a single edit that effects many labels. When data that affects any label is changed, the content manager module 22 will generate an image of the label and initiate an approval process using the traffic manager 24.

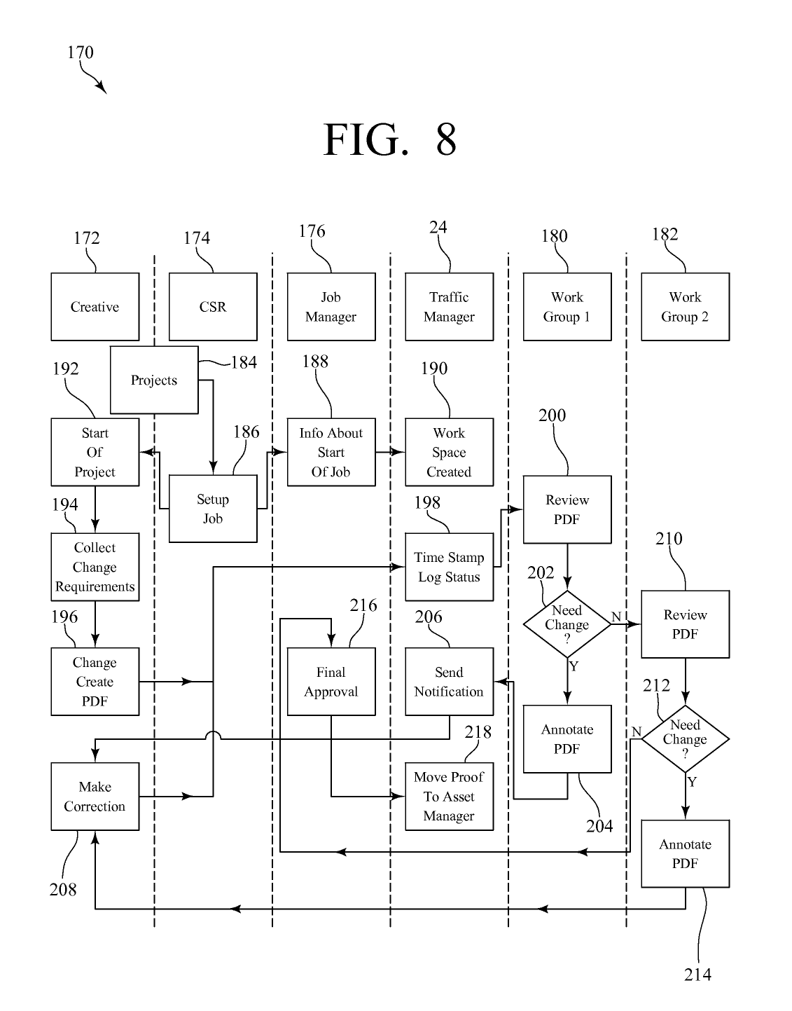

FIG. 8 shows the flow through a traffic management process 170, including steps by a creative entity 172, steps by a customer service representative 174, steps by a job manager 176, steps by the traffic manager module 24, steps by a first work group 180, and steps by a second work group 182. The traffic management process 170 can begin with the image of the label from the content manager module 22, or it may be utilized in a scenario where the content manager module 22 is not utilized. In the latter scenario, a request to change a label or create a new label would be received from a customer, and an image of the desired label would be created by a creative entity 172 (e.g. a pre-media department).

In either event, at the initiation of a project 184, a customer service representative 174 sets up a job 186. Information about the start of the job 188 is conveyed to the job manager 176. The job manager 176 then causes the traffic manager module 24 to create a work space 190 in the database 12 (FIG. 1).

In the event that the content manager module 22 is not utilized, the creative entity starts a project 192, collects change requirements 194, and creates an image of the desired label 196.

In the event that the content manager module 22 is utilized, the image of the desired label 196 is the image created by the content manager module 22.

The traffic manager module 24 then detects the image and a task notification is sent to the next process owner. The traffic manager module 24 also adjusts the print resolution to the best screen viewable size. A time stamp and status entry 198 is created in a historical record associated with the label identifier in the database 12. The time stamp and status entry 198 are used by the traffic manager module to monitor the process flow and to issue notifications and alerts for process flow times determined to exceed predetermined values.

Next, the first work group 180, such as a marketing department, will review the image 200 and determine if additional changes are needed 202. If additional changes are needed, an annotated image 204 is uploaded to the database 12, and the traffic manager module 24 sends a notification 206 to the creative entity 172. The creative entity 172 makes the correction 208, and a new image is created in the database 12, which begins the review process by the first work group 180 over again.

If the first work group 180 determines that additional changes are not needed, the second work group 182, such as a legal department, will review the image 210 and determine if further changes are needed 212. If additional changes are needed, an annotated image 214 is uploaded to the database 12, and the traffic manager module 24 sends a notification 206 to the creative entity 172. The creative entity 172 makes the correction 208, and a new image is created in the database 12, which begins the review process by the first work group 180 and the second work group 182 over again.

Any number of work groups may participate in the review and approval process, and the work groups may conduct the review and approval process either sequentially, as described, or concurrently using the traffic manager module 24.

If the second work group 182 determines that additional changes are not needed, the job manager 176 receives final approval 216, and causes the traffic manager module 24 to generate a high resolution image 218 for storage in the database 12 and management by the asset manager module 26.

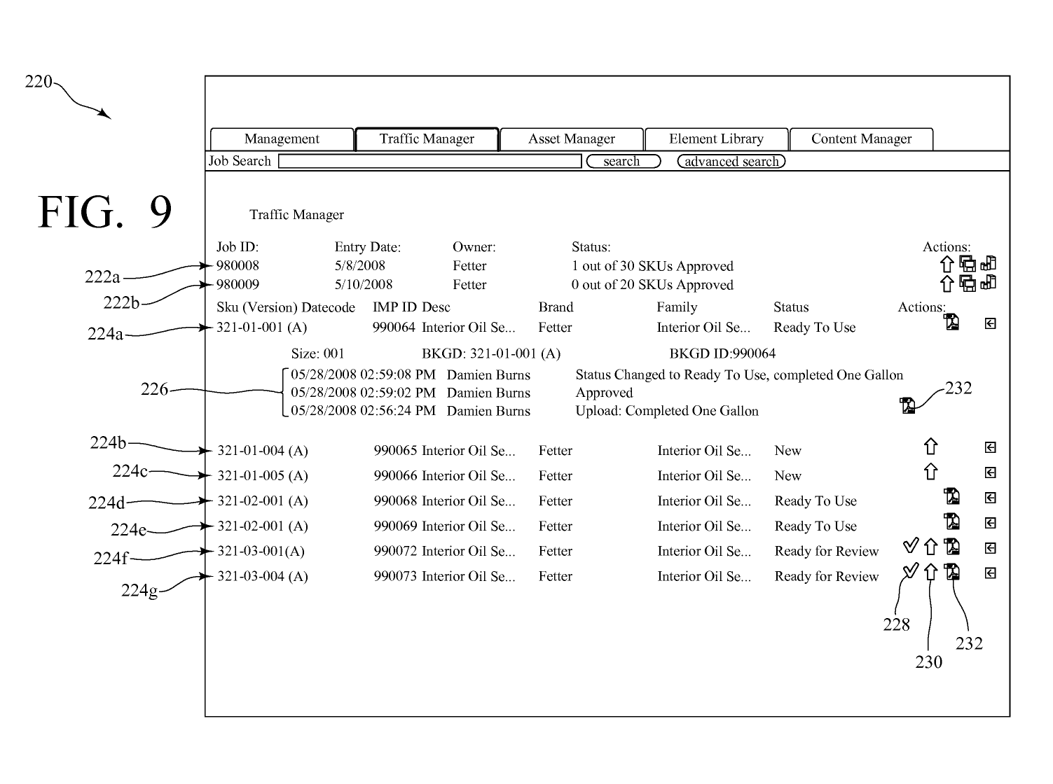

FIG. 9 is a screen shot of an exemplary user interface screen 220 for the traffic manager module 24, illustrating expandable headings for a first job 222a, a second job 222b and SKUs 224a-224g that are part of the second job 222b. Also shown is historical data 226 resulting from expanding one of the SKUs 224a. A job (e.g. 222a, 222b) is a holder for SKUs (e.g., 224a-224g) being worked on together. The historical data 226 shows a time stamp and a user ID for each change in status of the SKU during the approval process. Any SKU can be expanded to reveal the historical data (e.g. 226) associated with the SKU, and that historical data continues to be associated with the SKU even after the job (e.g. 222a, 222b) is completed.

Actions that can be taken with each SKU are represented by icons, including an approval icon 228, an upload icon 230 and a download icon 232. The approval icon 228 is present for SKUs 224f, 224g having a status of “Ready for Review” and indicates approval of the label. The upload icon 230 is present for SKUs 224f, 224g having a status of “Ready for Review” as well as for SKUs 224b, 224c having a status of “New.” The upload icon 230 allows the user to upload an annotated image to the database 12 (FIG. 1) for communicating the annotated image to the creative entity 172 (FIG. 6). The download icon 232 is present for SKUs 224f, 224g having a status of “Ready for Review” as well as for SKUs 224d, 224e having a status of “Ready to Use,” and indicates that an image of a label corresponding to the SKU is available to be downloaded. The download icon 232 is also present in the historical data 226 indicating that prior versions of images of a label corresponding to the SKU 224a are available. Thus, the entire approval process, including customer download, upload of annotated image, and approval is accomplished from this user interface screen 220 accessed by the customer through a network, such as the Internet. Additionally, historical data 226 can be tracked from this user interface screen 220.

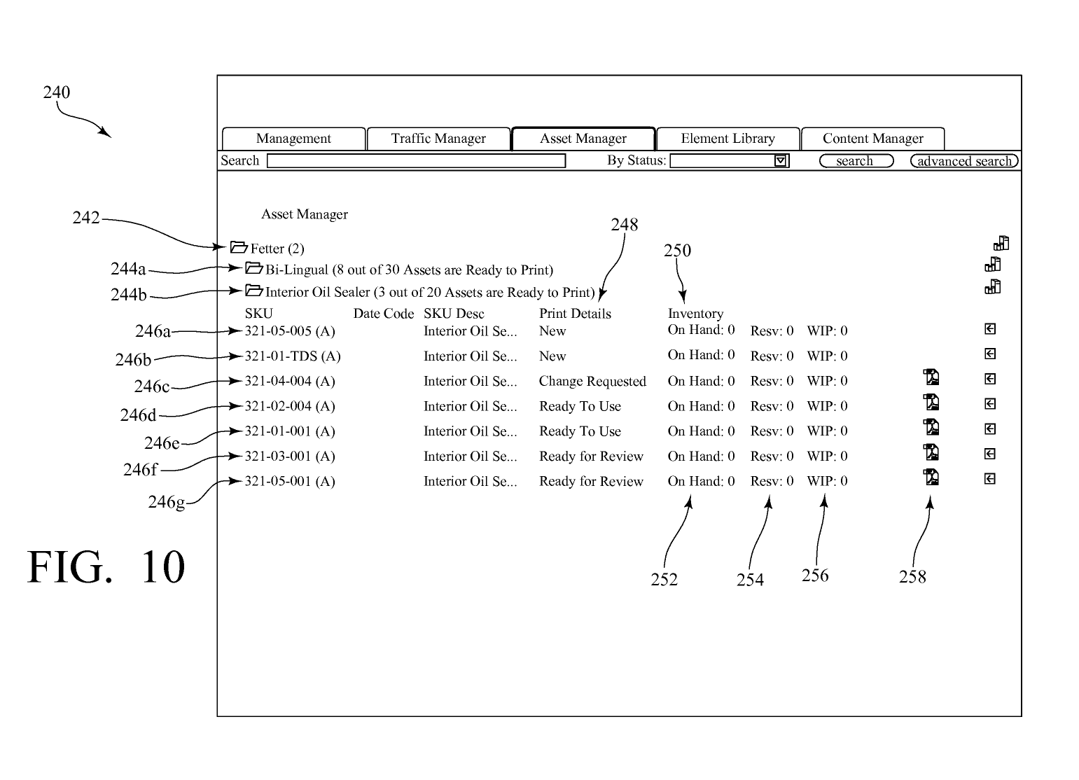

FIG. 10 is a screen shot of an exemplary user interface screen 240 for the asset manager module 26, illustrating expandable headings for a company 242, a first family 244a, a second family 244b, and SKUs 246a-246g that are part of the second family 244b. A status 248 (i.e. print details) is shown for each SKU 246a-246g. Also shown for each SKU 246a-246g is inventory information 250 indicating the quantities of printed labels that are on-hand 252, reserved (i.e., ordered) 254, and for which production is “in progress” 256. A download icon 258 is present for SKUs having an associated image that is available for review. The user interface screen 240 for the asset manager module 26 also provides search functionality for searching data in the database 12. All text data associated with each SKU 246a-246g is searchable. Historical data 226 (FIG. 9) associated with each SKU 246a-246g is also available through the user interface screen 240 of the asset manager module 26.

The status 248 indicates if the SKU is “Ready to Use” or if a change has been requested or a label is in the approval process. Advantageously, if a change is requested or a label is in the approval process, printing of the label can be restricted.

The inventory information 250 is obtained from the vendor that prints the labels, and may be real time information, or may be obtained at regular, timed intervals (e.g., nightly or weekly). Advantageously, the inventory information 250 is presented for use by the customer in making decisions about changing labels, as it may be undesirable to change a label for which a large inventory is present, thereby making the existing inventory obsolete.

The download icon 258 allows an image of the most recent version of the label to be easily located and viewed. Thus, for example, a visual comparison can easily be made between a physical label and the image of the most recent version to verify that the physical label is the most recent version.

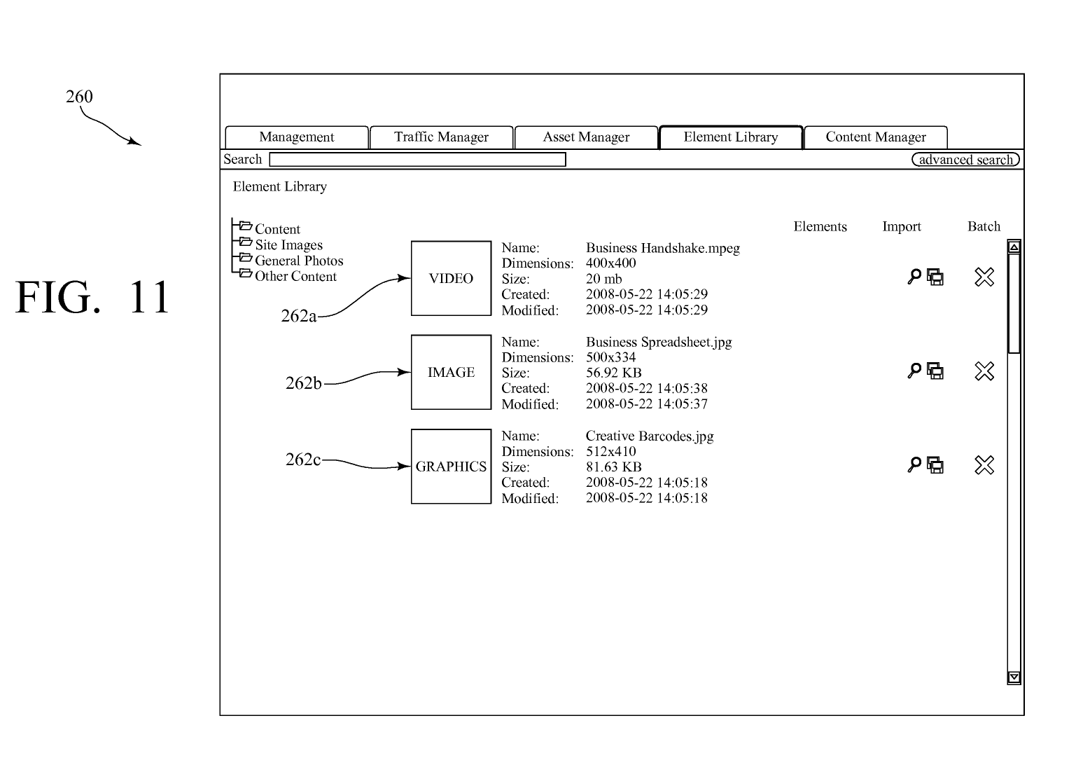

FIG. 11 is a screen shot of an exemplary user interface screen 260 for the element library module 28, showing information for electronic media files 262a-262c stored in the database 12 (FIG. 1). The information for electronic media files 262a-262c is searchable, and may include information regarding rights to the underlying electronic media, such as whether the electronic media is leased or purchased, who owns it, how long it can be used, how many times it can be used, etc. As such, access rights to the underlying electronic media may also be managed by the element library module 28.

Advantageously, the customer may choose to store electronic media files on the database 12 for access through the user interface screen 260 for the element library module, for safe and reliable management of those files. Further the administrator of the system 10 provides back-up and safekeeping of the database 12.

Thus, the invention provides a system and method for creating and managing label content. While the above description has used labels as an example, one of skill in the art will recognize that the spirit and scope of the following claims to the invention cover any printable asset having some or all of the characteristics of the labels described above (e.g. a family/product/SKU hierarchical structure, an approval process, and a need for managing assets including tracking the history of the asset and determining a current inventory status for the asset).

One of ordinary skill in the art will recognize that additional steps and configurations are possible without departing from the teachings of the invention. This detailed description, and particularly the specific details of the exemplary embodiment disclosed, is given primarily for clearness of understanding and no unnecessary limitations are to be understood therefrom, for modifications will become evident to those skilled in the art upon reading this disclosure and may be made without departing from the spirit or scope of the claimed invention.

What is claimed is:

1. A system for creating and managing content for a plurality of labels, comprising:
a database containing images of each of the plurality of labels;
a server in communication with the database and accessible to a plurality of customers over a network, the server including:
a traffic manager module for providing a user interface to a customer for customer review and approval of at least one of the plurality of labels following a change of the at least one of the plurality of labels; and
an asset manager module for obtaining inventory information indicating a current inventory status of each of the plurality of labels, and for providing a user interface to the customer for accessing the images and the inventory status of each of the plurality of labels over the network.

2. The system of claim 1,
wherein each label has a plurality of label fields and belongs to of one of a plurality of product lines that each comprise a plurality of different labels for different stock keeping units (SKUs);
wherein the database further has a product level of data and a SKU level of data for the plurality of label fields, the product level of data and the SKU level of data having a hierarchical relationship such that plurality of label fields use the product level of data unless exception data is present at the SKU level of data;
the system further comprising a content manager module for providing a user interface for editing the product level of data and the SKU level of data for the plurality of label fields, and for generating an image of any label affected by the editing.

3. The system of claim 2, wherein the database further has a family level of data having a hierarchical relationship with the product level of data and the SKU level of data such that the plurality of label fields use the family level of data unless exception data is present at one of the product level of data and the SKU level of data.

4. The system of claim 1, further comprising a management module for providing a user interface for assigning user rights to the system, and for defining jobs within the system.

5. The system of claim 1, wherein the database further contains a plurality of electronic media files, the system further comprising an element library module for providing a user interface to the customer for managing the plurality of electronic media files over the network.

6. A method for creating and managing a plurality of labels, comprising:
in response to receiving a request from a customer to change a label, changing the label as requested;
uploading a low resolution image of the label to a database for customer review over a network;
in response to receiving an approval signal from the customer over the network, the approval signal indicating approval of the label, generating a high resolution image of the label;
storing the high resolution image of the label to the database for access by the customer over the network;
obtaining inventory information indicating a current inventory status of the label; and
storing the inventory information to the database for access by the customer over the network.

7. The method of claim 6, further comprising sending a notification to the customer that the low resolution image is ready for review following uploading the low resolution image of the label to the database.

8. The method of claim 7, further comprising receiving an annotated image with additional changes from the customer following the customer review, making the additional changes, uploading a new image of the label to the database for further customer review over the network, and sending a notification to the customer that the new image is ready for review.

9. The method of claim 6, wherein said customer review is conducted by a plurality of customer reviewers, each of said plurality of customer reviewers reviewing the low resolution image of the label over the network.

10. The method of claim 6, further comprising storing a history of all actions taken with respect to the label in the database for access by the customer over the network.

11. The method of claim 6, wherein the label contains text data, further comprising storing a copy of the text data to the database for searching by the customer over the network.

12. A method for creating and managing content for a plurality of labels, comprising:
in response to receiving a request from a customer to create a plurality of labels that belong to one of a plurality of product lines that each comprise a plurality of different labels for different stock keeping units (SKUs), creating design templates for the labels, the design templates having a plurality of label fields for different parts of the labels;
creating in a database a product level of data and a SKU level of data for the plurality of label fields, the product level of data and the SKU level of data having a hierarchical relationship such that plurality of label fields use the product level of data unless exception data is present at the SKU level of data;
generating images of the labels from the design templates and data from the database; and
storing the images of the labels for customer review and approval over a network.

13. The method of claim 12, further comprising:
in response to a request to change the labels of a product line, changing the product level of data;
generating a new image of each label of the product line; and
storing the new image of each label of the product line for customer review and approval over a network.

14. The method of claim 12, wherein the plurality of product lines belong to a family of products, further comprising creating in the database a family level of data having a hierarchical relationship with the product level of data and the SKU level of data such that the plurality of label fields use the family level of data unless exception data is present at one of the product level of data and the SKU level of data.

15. The method of claim 14, further comprising:
in response to a request to change the labels of the family of products, changing the family level of data;
generating a new image of each label of the family of products; and
storing the new image of each label of the family of products for customer review and approval over a network.
